(19) United States
(12) Patent Application Publication
(10) Pub. No.: US 2013/0219989 A1
(43) Pub. Date: Aug. 29, 2013

(54) FUEL PROPERTY DETECTING DEVICE

(71) Applicant: DENSO CORPORATION, (US)

(72) Inventor: Jun Tarui, Kariya-city (JP)

(73) Assignee: DENSO CORPORATION, Kariya-city (JP)

(21) Appl. No.: 13/771,132

(22) Filed: Feb. 20, 2013

(30) Foreign Application Priority Data
Feb. 23, 2012 (JP) 2012-37540

(51) Int. Cl. G01N 27/22

(52) U.S. Cl. CPC G01N 27/22
USPC 73/23.31

(57) ABSTRACT

A fuel property detecting device includes an electrode part; a voltage conversion part; a standard voltage application part; an amplifying part; a temperature detection unit; a storage unit; a first calculation unit; a second calculation unit for calculating alcohol concentration in fuel based on capacitance calculated by the first unit, present fuel temperature, and a map indicating a first relationship between capacitance and fuel temperature; a third calculation unit; a conductivity determination unit for determining whether present conductivity calculated by the third unit is a predetermined conductivity or larger; a fourth calculation unit for calculating a second relationship between conductivity and fuel temperature based on past conductivity, past fuel temperature, present conductivity calculated by the third unit, and present fuel temperature; and an abnormality determination unit for determining whether the electrode part is abnormal based on the second relationship, and a coefficient of temperature properties indicating the second relationship.

### CROSS REFERENCE TO RELATED APPLICATION

This application is based on Japanese Patent Application No. 2012-37540 filed on Feb. 23, 2012, the disclosure of which is incorporated herein by reference.

### TECHNICAL FIELD

The present disclosure relates to a fuel property detecting device that detects, for example, alcohol concentration in fuel.

### BACKGROUND

Conventionally, a fuel property detecting device that detects a concentration of alcohol contained in fuel in an internal combustion engine is known. The fuel property detecting device measures the amount of electric charge stored in an electrode part having electrodes immersed in fuel, and detects the alcohol concentration of fuel through the calculation of capacitance of the electrode part based on the measured amount of electric charge. An abnormality diagnosis device for a fuel property detection system which detects the alcohol concentration with high precision by changing an upper limit and a lower limit in a relationship between a dielectric constant of the electrode part and the alcohol concentration according to fuel temperature, is described in JP-A-2010-038052.

However, in the abnormality diagnosis device of the fuel property detection system described in JP-A-2010-038052, if there is a large amount of conductive foreign substances contained in fuel between the electrodes, the dielectric constant calculated from the amount of electric charge exceeds the upper limit or lower limit. The abnormality diagnosis device of the fuel property detection system diagnoses as abnormal despite the normal electrode part. Accordingly, there is a possibility that the fuel property detecting device including the electrode part which is normal may be replaced.

### SUMMARY

The present disclosure addresses at least one of the above issues.

According to the present disclosure, there is provided a fuel property detecting device including an electrode part, a voltage conversion part, a standard voltage application part, an amplifying part, a temperature detection means, a storage means, a first calculation means, a second calculation means, a third calculation means, a conductivity determination means, a fourth calculation means, and an abnormality determination means. The electrode part includes electrodes immersed in fuel, and is charged with or discharges an amount of electric charge which changes according to a concentration of alcohol contained in fuel between the electrodes. The voltage conversion part is configured to convert the amount of electric charge, with which the electrode part is charged or which is discharged by the electrode part, into a detection voltage. The standard voltage application part is configured to apply a standard voltage to the voltage conversion part. The amplifying part is configured to amplify the detection voltage and to output the amplified detection voltage. The temperature detection means is for detecting fuel temperature and for outputting a signal that is in accordance with the detected fuel temperature. The storage means is for storing: a map indicating a relationship between capacitance of the electrode part and the fuel temperature; a coefficient of a temperature property indicating a relationship between electric conductivity of the electrode part and the fuel temperature; a past electric conductivity of the electrode part; and the fuel temperature detected by the temperature detection means at time of calculation of the past electric conductivity, as a past fuel temperature. The first calculation means is for calculating the capacitance of the electrode part based on the amplified detection voltage outputted by the amplifying part. The second calculation means is for calculating the concentration of alcohol contained in fuel based on: the capacitance calculated by the first calculating means; a present fuel temperature detected by the temperature detection means; and the map. The third calculation means is for calculating a present electric conductivity of the electrode part based on the amplified detection voltage outputted by the amplifying part. The conductivity determination means is for determining whether the present electric conductivity calculated by the third calculation means is equal to or larger than a predetermined electric conductivity. The fourth calculation means is for calculating the relationship between the electric conductivity of the electrode part and the fuel temperature based on: the past electric conductivity; the past fuel temperature; the present electric conductivity calculated by the third calculation means; and the present fuel temperature. The abnormality determination means is for determining whether the electrode part is abnormal based on: the relationship between the electric conductivity of the electrode part and the fuel temperature calculated by the fourth calculation means; and the coefficient of the temperature property.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view illustrating a fuel supply system to which a fuel property detecting device in accordance with an embodiment is applied;

FIG. 2 is a sectional view illustrating the fuel property detecting device of the embodiment;

FIG. 3 is a circuit diagram illustrating the fuel property detecting device of the embodiment;

FIG. 4 is a flow chart for fuel property detection processing in the fuel property detecting device of the embodiment;

FIG. 5A is a diagram illustrating a temporal change of a level of pulse wave voltage applied to a switch according to the embodiment;

FIG. 5B is a diagram illustrating a temporal change of an electric current flowing through an electrode part of the fuel property detecting device of the embodiment;

FIG. 5C is a diagram illustrating a temporal change of an electric current flowing through the electrode part of the fuel property detecting device of the embodiment;

FIG. 6A is a diagram illustrating a temporal change of a level of the pulse wave voltage applied to the switch according to the embodiment;

FIG. 6B is a diagram illustrating a temporal change of voltage generated by a switched-capacitor circuit in the fuel property detecting device of the embodiment; and

FIG. 7 is a diagram illustrating a relationship between electric conductivity of the electrode part of the fuel property detecting device of the embodiment and fuel temperature.

### DETAILED DESCRIPTION

A fuel property detecting device of an embodiment will be described below in reference to the drawings. The fuel property detecting device is used for detecting ethanol concentration in mixed liquid of gasoline and ethanol as fuel supplied to an engine of a vehicle.

A fuel property detecting device 1 is disposed in a fuel supply system for the engine (not shown). The fuel property detecting device 1 is provided at a fuel pipe 4 connecting a fuel tank 2 and a delivery pipe 5. Fuel, in which gasoline and ethanol are mixed, is stored in the fuel tank 2. Any of mixed liquid of gasoline and ethanol, gasoline, and ethanol can be fed into the fuel tank 2. Accordingly, the ethanol concentration in fuel in the fuel tank 2 can change at the time of feeding the tank 2.

The fuel in the fuel tank 2 is pressure-fed to the delivery pipe 5 through the fuel pipe 4 by a fuel pump 3, to be injected from an injector 6 into an intake pipe or cylinder (not shown). Electrical drive control of the injector 6 is performed by an electronic control unit 7 (hereinafter referred to as “ECU”) of the engine.

The ECU 7 includes a microcomputer. A detecting signal from the fuel property detecting device 1, and various kinds of detecting signals related to the engine are inputted into the ECU 7. In the present embodiment, in order to operate the engine under optimum conditions that the amount of harmful substances contained in exhaust gas is minimum, and fuel efficiency is maximum, ethanol concentration of fuel supplied to the engine is detected by the fuel property detecting device 1. In accordance with the detected ethanol concentration, the ECU 7 controls appropriately various kinds of control parameters such as an air-fuel ratio, fuel injection quantity, and ignition timing. To operate the engine under the optimum conditions, the fuel property detecting device 1 may be disposed to detect an ethanol concentration at a closest possible position to the injector 6.

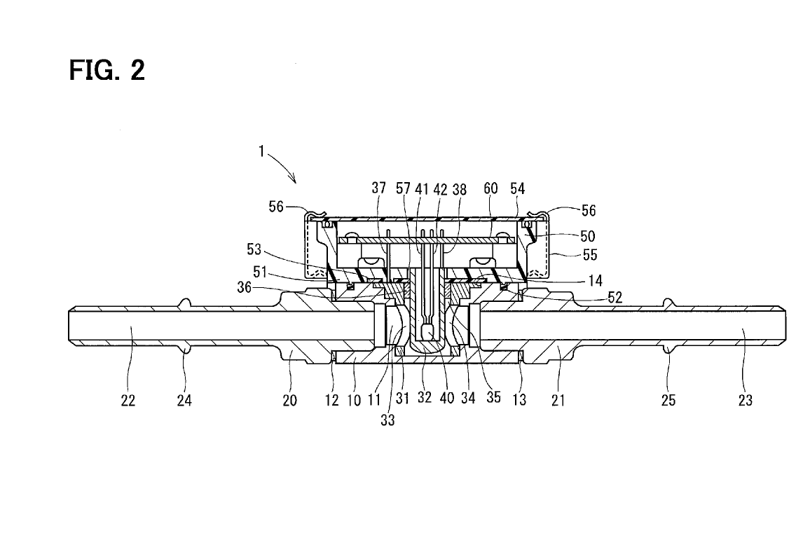

As illustrated in FIG. 2, the fuel property detecting device 1 includes a first housing 10, connecting pipes 20, 21, a first electrode 31, a second electrode 32, a thermistor 40, a second housing 50, and a circuit part 60.

The first housing 10 is formed cylindrically from metal such as stainless steel. A combustion chamber 11 is formed inside the first housing 10. The connecting pipes 20, 21 are screwed on both ends of the first housing 10 in an axial direction (right and left directions in FIG. 2) with sealing members 12, 13 therebetween.

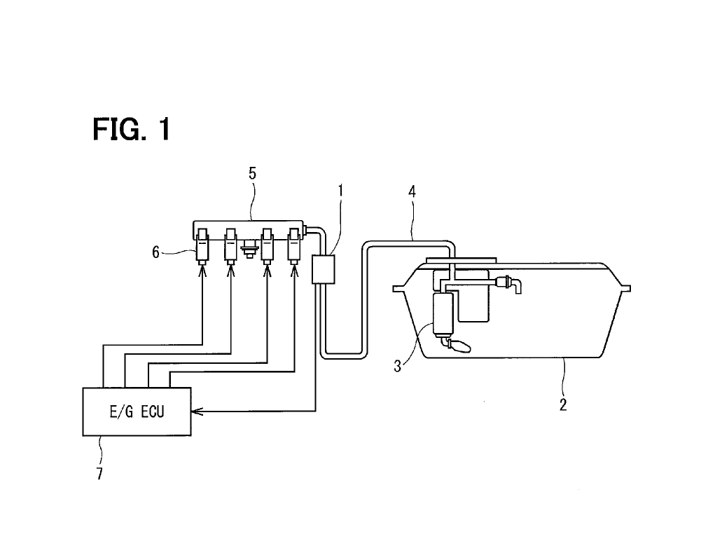

The connecting pipes 20, 21 are formed cylindrically from metal such as stainless steel. A passage 22 is formed inside the connecting pipe 20, and a passage 23 is formed inside the connecting pipe 21. The passages 22, 23 communicate with the combustion chamber 11. A pawl 24 projecting radially outward of the pipe 20 is formed at a predetermined position of the connecting pipe 20 in its axial direction. A pawl 25 projecting radially outward of the pipe 21 is formed at a predetermined position of the connecting pipe 21 in its axial direction. The connecting pipes 20, 21 are connected to the fuel pipe 4 (see FIG. 1) through a connector (not shown) connected to the pawls 24, 25. Accordingly, fuel is supplied to the passage 22 of the connecting pipe 20, the passage 23 of the connecting pipe 21, and the combustion chamber 11 of the first housing 10.

The first electrode 31 is formed cylindrically from metal such as stainless steel. The first electrode 31 is inserted in the combustion chamber 11 of the first housing 10 through an opening 14 formed on one side of the first housing 10 in its radial direction, generally perpendicular to the axial direction of the first housing 10.

The second electrode 32 is formed from metal such as stainless steel in a cylindrical shape having a bottom, and is accommodated in a space 35 which is formed radially inward of the first electrode 31. A glass seal 36 is provided between an inner wall of the first electrode 31 radially inward thereof and an outer wall of the second electrode 32 radially outward thereof. Accordingly, the first electrode 31 and the second electrode 32 are fixed together. Moreover, the glass seal 36 insulates the first electrode 31 electrically from the second electrode 32.

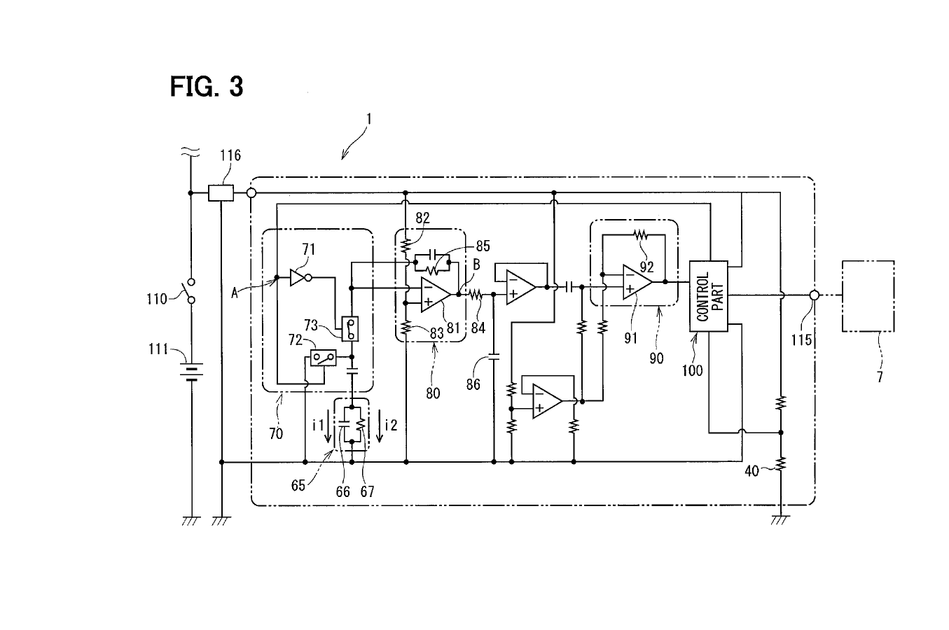

The first electrode 31 includes fuel holes 33, 34 which communicate in the radial direction of the electrode 31. The fuel in the combustion chamber 11 of the first housing 10 flows through the fuel holes 33, 34 into the space 35 formed between the inner wall of the first electrode 31 radially inward thereof and the outer wall of the second electrode 32 radially outward thereof. Accordingly, the first electrode 31 and the second electrode 32 function as a capacitor with the fuel which has flowed into the space 35 being a dielectric substance. This capacitor is indicated as a “capacitor 66” in a circuit diagram in FIG. 3. Details of the capacitor 66 will be described below.

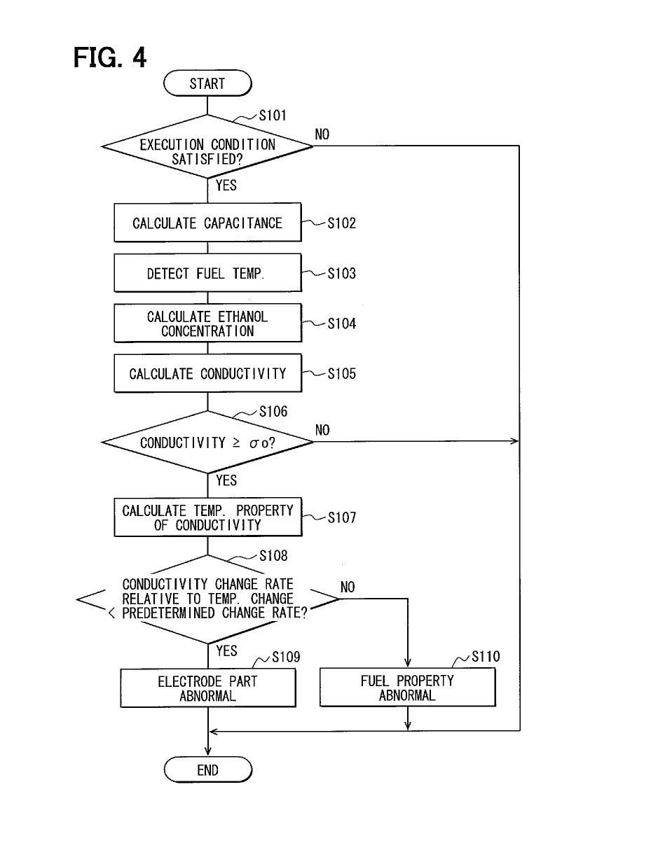

The thermistor 40 is a temperature detecting element whose electric resistance varies according to temperature change. The thermistor 40 as a “temperature detection means (S103 in FIG. 4)” is accommodated in the second electrode 32, and is in contact with an inner wall of the bottom part of the second electrode 32. Since the temperature of the inner wall of the bottom part of the second electrode 32 is the same as the temperature of fuel in the space 35, the thermistor 40 detects the fuel temperature of the space 35 via the bottom part of the second electrode 32. In addition, a clearance between the inner wall of the bottom part of the second electrode 32 and the thermistor 40 may be filled up with a heat conduction member such as heat release grease.

The second housing 50 is formed from, for example, resin in a cylindrical shape having a bottom, and its bottom part 51 is fixed at a position corresponding to the opening 14 of the first housing 10. A receiving hole 57 is provided for the bottom part 51 of the second housing 50, and the hole 57 receives an end portion of the second electrode 32 that is not immersed in fuel.

An annular packing 52 and a plate-shaped resilient member 53 are provided between the second housing 50 and the first housing 10. The packing 52 prevents entry of water, for example, into between the second housing 50 and the first housing 10 from the outside of the device 1. The resilient member 53 includes an opening generally at its center, and the second electrode 32 is fitted in this opening.

A plate-shaped cover 54 is provided at an opening of the second housing 50 on its opposite side from the first housing 10 to prevent entry of water, for example, into the second housing 50 from the outside. The cover 54 is fixed by a plate-shaped spring 56 which is engaged with an engaging part 55 projecting radially outward of the second housing 50. Accordingly, the first electrode 31 is pressed on the first housing 10 by way of the resilient member 53.

The circuit part 60 includes electronic components provided on a printed-wiring board, and is accommodated inside the second housing 50. The circuit part 60 and the first electrode 31 are connected by a first conductor 37. The circuit part 60 and the second electrode 32 are connected by a second conductor 38. The circuit part 60 and the thermistor 40 are connected by a third conductor 41 and a fourth conductor 42.

A circuit configuration of the fuel property detecting device 1 will be described in reference to FIGS. 2 and 3. Electric power is supplied from a battery 111 to the fuel property detecting device 1 via an ignition switch 110. A output terminal 115 of the fuel property detecting device 1 is connected to the ECU 7. The signal outputted by the fuel property detecting device 1 is inputted into the ECU 7.

A constant voltage regulator 116 is provided between the fuel property detecting device 1 and the battery 111. In the constant voltage regulator 116, the voltage from the battery 111 is converted into a predetermined voltage for stabilization. In the present embodiment, a battery voltage of, for example, 12V is converted into 5V by the constant voltage regulator 116 to be applied to the fuel property detecting device 1.

The fuel property detecting device 1 includes an electrode part 65, a switched-capacitor circuit 70 as a “voltage conversion part”, a standard voltage generation circuit 80 as a “standard voltage application part”, an amplifying circuit 90 as an “amplifying part”, and a control part 100. In the present embodiment, the electronic components such as the switched-capacitor circuit 70, the standard voltage generation circuit 80, the amplifying circuit 90, and the control part 100 are disposed on the circuit part 60.

The electrode part 65 includes the first electrode 31, the second electrode 32, and the fuel flowing into the space 35 (see FIG. 2). The fuel which flows into the space 35 serves as a dielectric substance, and the first electrode 31, the second electrode 32, and the fuel flowing into the space 35 constitute a capacitance object. This capacitance object is indicated as the capacitor 66 in FIG. 3.

There is a leakage resistance which is an electric resistance via the fuel flowing into the space 35 between the first electrode 31 and the second electrode 32. The leakage resistance can be regarded as connected in parallel with the capacitor 66 on the electric circuit, and is indicated in FIG. 3 as a leakage resistance 67 connected in parallel with the capacitor 66. The leakage resistance 67 changes according to fuel properties such as a water content.

The switched-capacitor circuit 70 includes an inverter 71 and two switches 72, 73. As two kinds of pulse wave voltages having different frequencies, a first frequency pulse wave voltage Va1 whose frequency is a first frequency f1, and a second frequency pulse wave voltage Va2 whose frequency is a second frequency f2, are applied to a point A in the switched-capacitor circuit 70 from the control part 100. The two switches 72, 73 are both closed when applied pulse wave voltages are at a high level, and open when the pulse wave voltages are at a low level. The pulse wave voltage from the control part 100 is applied directly to the one switch 72. The pulse wave voltage from the control part 100 is applied via the inverter 71 to the other switch 73. Accordingly, the pulse wave voltages whose frequencies are the same and which are opposite in phase are applied to the switch 72 and the switch 73. For example, when the pulse wave voltage applied to the switch 72 is at a high level, the pulse wave voltage applied to the switch 73 reaches a low level. At this time, the switch 72 is closed, and the switch 73 is open. When the pulse wave voltage applied to the switch 72 is at a low level, the pulse wave voltage applied to the switch 73 reaches a high level. At this time, the switch 72 is open, and the switch 73 is closed. Therefore, the opening-closing operation of the switch 72 and the opening-closing operation of the switch 73 are opposite in timing. Accordingly, when the first frequency pulse voltage Va1 is applied to the switched-capacitor circuit 70 from the control part 100, the switches 72, 73 are opened and closed with the first frequency f1 and with the opposite timings. When the second frequency pulse voltage Va2 is applied to the switched-capacitor circuit 70 from the control part 100, the switches 72, 73 are opened and closed with the second frequency f2 and with the opposite timings.

The standard voltage generation circuit 80 includes an operational amplifier 81 and resistances 82, 83, 85. The standard voltage generation circuit 80 divides the voltage stabilized by the constant voltage regulator 116 in a ratio between respective resistance values of the resistances 82, 83, to be inputted into an inversed input terminal of the operational amplifier 81. The voltage outputted by the switched-capacitor circuit 70 is inputted into a non-inversed input terminal of the operational amplifier 81. Thus, the operational amplifier 81 amplifies the voltage outputted from the switched-capacitor circuit 70 to be outputted to a point B in the standard voltage generation circuit 80. The resistance 85 which electrically connects an output terminal of the operational amplifier 81 and the switched-capacitor circuit 70 is provided in the standard voltage generation circuit 80.

The amplifying circuit 90 includes an operational amplifier 91, and a gain resistance 92 provided in parallel with the operational amplifier 91. The amplifying circuit 90 further amplifies the voltage outputted by the standard voltage generation circuit 80, to be outputted to the control part 100.

The control part 100 is operated as a result of application of the voltage stabilized by the constant voltage regulator 116. The control part 100 is configured by, for example, a know microcomputer. The voltage outputted by the amplifying circuit 90 and the voltage outputted by the thermistor 40 are inputted into the control part 100. The control part 100 performs fuel property detection processing (described below) based on these inputted voltages. The result of fuel property detection processing is outputted to the ECU 7 via the output terminal 115. The control part 100 may correspond to a “storage means”, a “first calculation means (S102 in FIG. 4)”, a “second calculation means (S104)”, a “third calculation means (S105)”, a “conductivity determination means (S106)”, a “fourth calculation means (S107)”, and an “abnormality determination means (S108)”.

The thermistor 40 is connected electrically to the control part 100. The thermistor 40 detects the fuel temperature by use of the voltage applied to the constant voltage regulator 116. The thermistor 40 outputs a voltage that is in accordance with the detected fuel temperature to the control part 100.

The fuel property detection processing by the fuel property detecting device 1 will be described with reference to FIGS. 3 to 7. In the fuel property detection processing by the fuel property detecting device 1 of the present embodiment, ethanol concentration of fuel, fuel temperature, and electric conductivity of fuel are calculated based on the voltages inputted into the control part 100. In addition, based on a temperature property of the calculated conductivity, it is determined whether abnormality is caused in the electrode part 65.

At The first step (“step” is abbreviated hereinafter as “S”) 101, it is determined whether an execution condition for the fuel property detection processing is satisfied. This execution condition may be, for example, that the battery voltage is a predetermined value or higher, or that the fuel stored in the fuel tank 2 is a predetermined quantity or larger. If it is determined that the execution condition is satisfied, control proceeds to S102. If it is determined that the execution condition is not satisfied, control ends the fuel property detection processing.

Next, the capacitance of the capacitor 66 is calculated at S102. A method for the calculation of capacitance in the fuel property detecting device 1 of the present embodiment will be described in reference to FIGS. 3, 5A to 5C, 6A and 6B.

The control part 100 applies the first frequency pulse wave voltage Va1 and the second frequency pulse wave voltage Va2 alternately to the point A in the switched-capacitor circuit 70. As described above, upon application of the first frequency pulse wave voltage Va1 and the second frequency pulse wave voltage Va2 to the point A, the switches 72, 73 are opened and closed with periods in synchronization with frequencies of the applied pulse wave voltages and with the opposite timings (alternately).

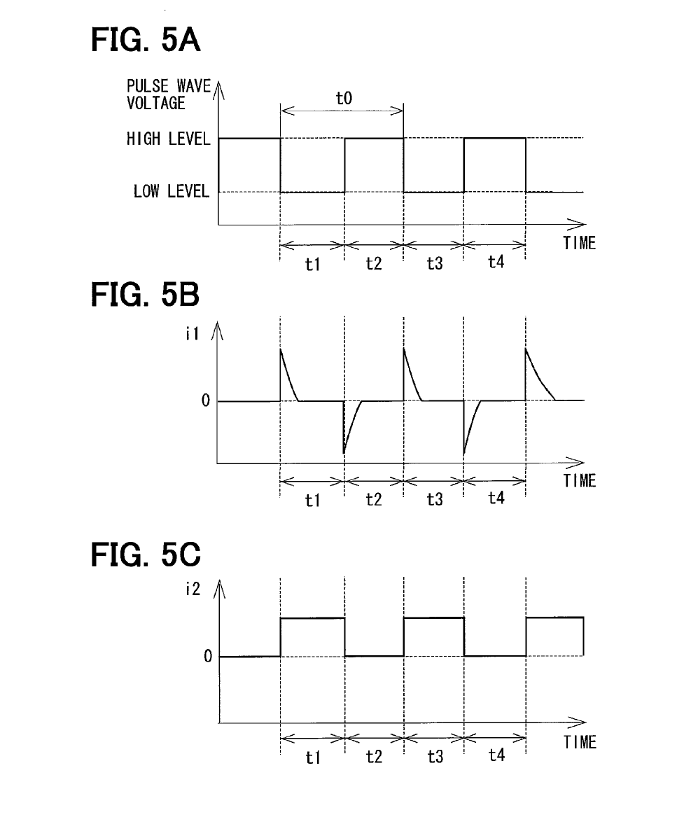

When the switch 72 is open, and the switch 73 is closed corresponding to the frequencies of the applied pulse wave voltages, a standard voltage E is applied to the electrode part 65 from the standard voltage generation circuit 80 through the switch 73. As illustrated in FIG. 3, an electric current i1 flows through the capacitor 66, and an electric current i2 flows through the leakage resistance 67. As indicated by times t1, t3 in FIG. 5B, the electric current i1 rises immediately after the standard voltage E is applied, and when the charge of the capacitor 66 is completed, the electric current i1 drops to 0 (zero). The electric current i2 has a constant value while the standard voltage E is applied to the electrode part 65 (FIG. 5C). In FIG. 5A, one period of a temporal change of the pulse wave voltage corresponds to time to.

On the other hand, when the switch 72 is closed, and the switch 73 is open, the standard voltage E is not applied to the electrode part 65 from the standard voltage generation circuit 80 via the switch 73; and the electric current i1 flows toward the ground side from the capacitor 66, which has been charged with the electric current via the switch 72 (opposite direction from an arrow of the electric current i1 in FIG. 3). Thus, as indicated by times t2, t4 in FIG. 5B, a flow direction of the electric current i1 is opposite from the above case of the switch 72 being open and the switch 73 being closed. Upon completion of discharge of the capacitor 66, the electric current i1 reaches 0 (zero). The electric current i2 flowing through the leakage resistance 67 is 0 (zero). As described above, in the switched-capacitor circuit 70, by switching between the opening and closing of the switches 72, 73, a charge state in which electric charge is stored in the capacitor 66, and a discharge state in which electric charge is discharged from the capacitor 66, are switched.

The voltage outputted from the operational amplifier 81, i.e., a point B voltage Vb which is the voltage at the point B in the standard voltage generation circuit 80, when the opening and closing of the switches 72, 73 are switched with the first frequency f1 or the second frequency f2, will be described below.

An average value of the electric current i2 flowing through the leakage resistance 67 is expressed by the following equation (1).

i2=0.5×E/Rp (1)

where “Rp” is a resistance value of the leakage resistance 67.

Electric charge ΔQ stored in the capacitor 66 is expressed by the following equations (2) given that the capacitance of the capacitor 66 is Cp.

ΔQ=Cp/E (2)

Because an average value of the electric current i1 is temporal differentiation of the electric charge ΔQ, it is expressed by the following equations (3).

$$\begin{matrix}i 1 = Δ Q / t \\ = Cp \times E / t \\ = Cp \times E \times f\end{matrix} \qquad ( 3 )$$

where “t” is a period and is a reciprocal (1/f) of the frequency f.
As is clear from the equations (3), the electric current i1 discharged from the capacitor 66 is proportional to the frequency f of the pulse wave voltage applied to the point A.

The point B voltage Vb is expressed by the following equations (4) using the equations (1) (3).

$$\begin{matrix}Vb = E + Rg \times ( i 1 + i 2 ) \\ = E + Rg \times \{ ( Cp \times E / t ) + 0.5 \times E / Rp \} \\ = E \times \{ 1 + ( 0.5 \times Rg / Rp ) + Rg \times Cp \times f \}\end{matrix} \qquad ( 4 )$$

where “Rg” is a resistance value of the resistance 85.

The resistance value Rp of the leakage resistance 67 is included in the equations (4) expressing the point B voltage Vb which varies according to the ethanol concentration in fuel. The resistance value Rp is changed by a rate of conductive foreign substances such as water contained in fuel. Accordingly, in the present embodiment, the influence of the leakage resistance 67 is eliminated through the alternant application of two kinds of pulse wave voltages having different frequencies to the switched-capacitor circuit 70.

The point B voltage Vb1 when the switches 72, 73 are opened and closed with the first frequency f1 is expressed by the following equation (5).

Vb1=E×{1+(0.5×Rg/Rp)+Rg×Cp×f1} (5)

The point B voltage Vb2 when the switches 72, 73 are opened and closed with the second frequency f2 is expressed by the following equation (6).

Vb2=E×{1+(0.5×Rg/Rp)+Rg×Cp×f2} (6)

A difference between the point B voltage Vb1 when the switches 72, 73 are opened and closed with the first frequency f1, and the point B voltage Vb2 when the switches 72, 73 are opened and closed with the second frequency f2, is expressed by the following equation (7).

Vb1−Vb2=E×(f1−f2)×Rg×Cp (7)

As indicated in the equation (7), the capacitance of the capacitor 66 is calculated by use of the point B voltage Vb1 when the switches 72, 73 are opened and closed with the first frequency f1, and the point B voltage Vb2 when the switches 72, 73 are opened and closed with the second frequency f2.

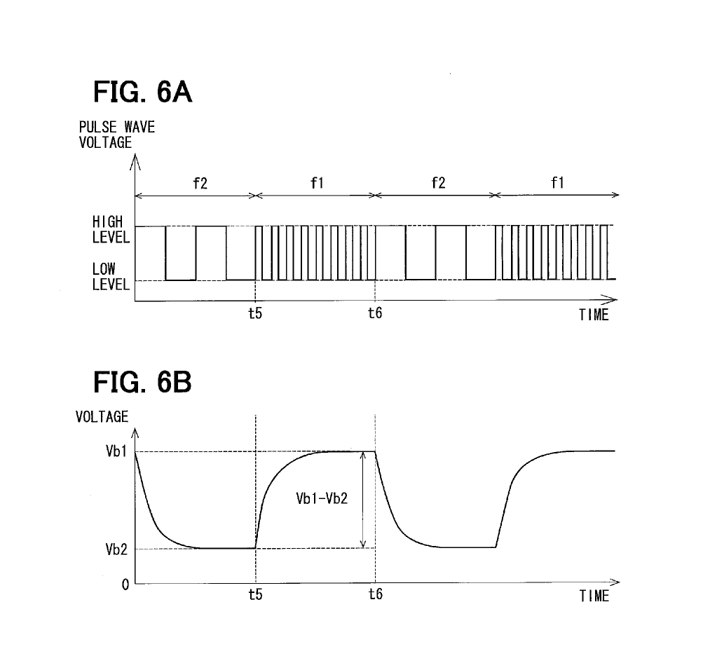

FIGS. 6A and 6B are diagrams illustrating the change of the smoothed point B voltage Vb. The point B voltage Vb outputted from the operational amplifier 81 is smoothed by a resistance 84 and a capacitor 86 illustrated in FIG. 3. In FIG. 6A, the switching of the switches 72, 73 is carried out first with the pulse wave of the second frequency f2, and it is almost converged by time t5. Moreover, the switching of the switches 72, 73 is carried out with the pulse wave of the first frequency f1 from the time t5, and it is nearly converged by time t6.

Therefore, switching timing between the first frequency f1 and the second frequency f2 is controlled by the control part 100, and the control can be performed based on such a change of the point B voltage Vb.

At S102, the capacitance of the capacitor 66 is calculated based on a difference between the point B voltage Vb1 at the time of application of the first frequency pulse wave voltage Va1 of the first frequency f1 to the point A, and the point B voltage Vb2 at the time of application of the second frequency pulse wave voltage Va2 of the second frequency f2 to the point A.

After that, the present fuel temperature T2 is detected at S103. The present fuel temperature T2 is calculated in the control part 100 from the voltage value outputted from the thermistor 40.

Subsequently, the ethanol concentration in fuel is calculated at S104. The capacitance of the capacitor 66 calculated at S102 includes a correlation relationship with the ethanol concentration and fuel temperature. Specifically, when the fuel temperature is constant, the capacitance becomes greater as the ethanol concentration becomes higher. Furthermore, when the ethanol concentration is constant, the capacitance becomes smaller as the fuel temperature becomes higher. The control part 100 includes a map on which a relationship between the capacitance and temperature with respect to various ethanol concentrations is recorded. In the control part 100, a temperature correction is performed on the capacitance calculated using the map at S102 by the present fuel temperature T2 detected at S103, to calculate the ethanol concentration in fuel.

Then, the present electric conductivity σ2 between the first electrode 31 and the second electrode 32 of the capacitor 66 is calculated at S105. A relationship between an electric conductivity σ between the first electrode 31 and the second electrode 32, and the point B voltages Vb1, Vb2 used at the time of calculation of the capacitance of the capacitor 66, is expressed by the following formula (8).

σ∝(Vb1+Vb2)/2 (8)

Accordingly, the control part 100 calculates the present electric conductivity σ2 between the first electrode 31 and the second electrode 32 from the point B voltages Vb1, Vb2 using the formula (8).

Next, it is determined at S106 whether the present electric conductivity σ2 is equal to or larger than a predetermined electric conductivity σ0. The predetermined electric conductivity σ0 is stored beforehand in the control part 100. The control part 100 makes a comparison of a large and small relation between the present electric conductivity σ2 calculated at S105 and the predetermined electric conductivity σ0. If it is determined that the present electric conductivity σ2 is equal to or larger than the predetermined electric conductivity σ0, control proceeds to S107. If it is determined that the present electric conductivity σ2 is smaller than the predetermined electric conductivity σ0, control ends the fuel property detection processing.

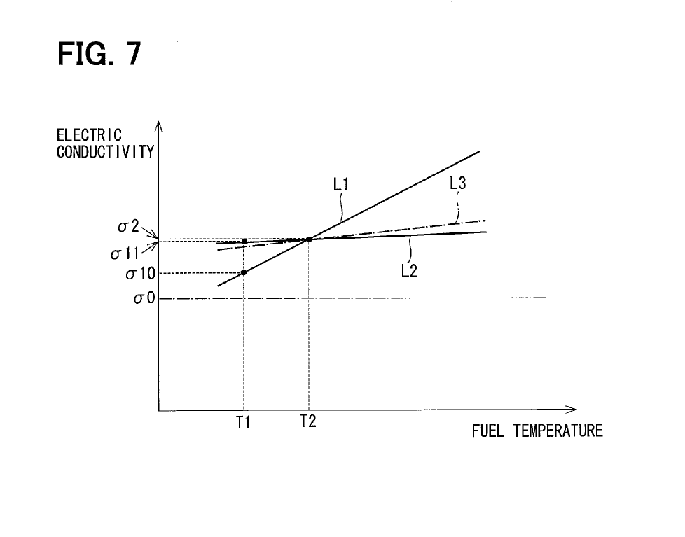

Successively, temperature properties of the electric conductivity σ between the first electrode 31 and the second electrode 32 are calculated at S107. The “past electric conductivity” calculated in the fuel property detection processing performed at the time prior to the currently-implemented fuel property detection processing, and the “past fuel temperature” at the time of calculation of the past electric conductivity, are stored in the control part 100. Accordingly, in the control part 100, the temperature properties of the electric conductivity σ between the first electrode 31 and the second electrode 32 are calculated based on the past electric conductivity and the past fuel temperature, and the present electric conductivity σ2 and the present fuel temperature T2. The “past electric conductivity” and the “past fuel temperature” may be, for example, electric conductivity and fuel temperature calculated in the fuel property detection processing performed when the fuel temperature is low immediately after an engine start. Specifically, the temperature properties of the electric conductivity σ show a relationship as indicated by a straight line L2 or L1 in FIG. 7.

Next, based on the temperature properties of the electric conductivity σ calculated at S107, it is determined at S108 whether a change rate of the electric conductivity σ relative to a change of fuel temperature is smaller than a predetermined change rate as a “coefficient of a temperature property”. The method for the determination will be explained in reference to FIG. 7. When electric conductivity of fuel at the past fuel temperature T1 is the past electric conductivity σ10, from its relationship with the present electric conductivity σ2 at the present fuel temperature T2 detected at S103 in the currently-implemented fuel property detection processing, the temperature properties of the electric conductivity σ are expressed by the straight line L1 indicated in FIG. 7. A slope of the straight line L1 indicates the change rate of the electric conductivity σ relative to the change of fuel temperature. The slope of the straight line L1 is larger than a slope of a straight line L3 with the predetermined change rate being its slope. On the other hand, when electric conductivity of fuel at the past fuel temperature T1 is the past electric conductivity σ11, from its relationship with the electric conductivity σ2 of fuel at the present fuel temperature T2 detected at S103 in the currently-implemented fuel property detection processing, the temperature properties of the electric conductivity σ are expressed by the straight line L2 indicated in FIG. 7. A slope of the straight line L2 is smaller than the slope of the straight line L3 with the predetermined change rate being its slope. As described above, at S108, a comparison is made between the slope of the straight line derived from a relationship of the present electric conductivity and the present fuel temperature with the past electric conductivity and the past fuel temperature, and the slope of the predetermined straight line L3. If it is determined that the change rate of the electric conductivity σ relative to the change of fuel temperature is smaller than the predetermined change rate, control proceeds to S109. If it is determined that the change rate of the electric conductivity σ relative to the change of fuel temperature is equal to or larger than the predetermined change rate, control proceeds to S110.

At S109, the control part 100 determines that abnormity is caused in the electrode part 65, and the fuel property detection processing is ended. After this, upon determination of occurrence of abnormity in the electrode part 65, the control part 100 outputs a signal that transmits the abnormal electrode part 65 to the ECU 7. In response to the outputted signal, an alert is sent to a driver of the vehicle. Upon reception of this alert, the driver of the vehicle replaces the fuel property detecting device 1. On the other hand, the control part 100 determines at S110 that the properties of fuel are abnormal. More specifically, the control part 100 determines that, instead of the abnormal electrode part 65, the electric conductivity is equal to or larger than the predetermined electric conductivity due to the incorporation of many conductive foreign substances into fuel. Then, the fuel property detection processing is ended. In this case, the control part 100 performs the next fuel property detection processing without outputting the signal that transmits the abnormal electrode part 65. Alternatively, in this case, a warning signal for abnormity of the fuel property can be outputted.

Generally, in the case of mixing of the conductive foreign substances into fuel, which is regarded as the abnormal fuel properties, when the fuel temperature rises, the electric conductivity also rises. Accordingly, the change rate of the electric conductivity relative to the change of fuel temperature also becomes large. In this case, in the fuel property detecting device 1 of the embodiment, the slope of the straight line L1 is large as illustrated in FIG. 7. On the other hand, for example, in the case of the abnormal electrode part 65 as a result of a short circuit between the electrodes due to conductive foreign substances being sandwiched between the electrodes, the change rate of the electric conductivity relative to the change of fuel temperature is small relative to the case of incorporation of the conductive foreign substances. Thus, in the fuel property detecting device 1 of the embodiment, the slope of the straight line L2 is small as illustrated in FIG. 7.

In the fuel property detecting device 1 of the embodiment, depending on whether the slope of the straight line indicating the temperature properties of the electric conductivity σ is smaller than the slope of the straight line L3 indicating the predetermined change rate, it is determined that the electrode part 65 is abnormal or that the properties of fuel are abnormal. Conventionally, when electric conductivity is equal to or larger than a predetermined electric conductivity, with the thought of an electrode part being abnormal in any case, the electrode part is replaced. However, in the fuel property detecting device 1 of the embodiment, the abnormal electrode part 65 or the abnormal fuel properties is determined based on the temperature property of electric conductivity. In the case of the abnormal fuel properties, the next fuel property detection processing is performed without replacement of the electrode part 65. Accordingly, unnecessary replacement of the fuel property detecting device including the electrode part 65 can be prevented.

Modifications of the above embodiment will be described below. In the above embodiment, the fuel property detecting device detects the ethanol concentration in fuel. However, the mixed component in fuel detected by the fuel property detecting device is not limited to the above. Alcohol concentration such as methanol concentration or butanol concentration may be detected.

In the above embodiment, the present fuel temperature used at the time of calculation of the capacitance and the temperature property of electric conductivity is the fuel temperature detected at S103. However, the step to detect the present fuel temperature used at the time of calculation of the temperature property of electric conductivity is not limited to the above. The fuel temperature detected by the thermistor at the time of calculation of electric conductivity at S105 may also be employed.

The present disclosure is not limited to this embodiment, and can be embodied in various modes without departing from the scope of the disclosure.

To sum up, the fuel property detecting device 1 of the above embodiment can be described as follows.

In the first aspect of the disclosure, the fuel property detecting device 1 detects the concentration of alcohol contained in fuel based on the capacitance of the electrode part 65 having the electrodes 31, 32 immersed in fuel, and determines whether the electrode part 65 is abnormal based on the temperature property of electric conductivity of the electrode part 65. The electrode part 65 is charged with or discharges the amount of electric charge that varies according to the concentration of alcohol contained in fuel between the electrodes 31, 32. The voltage conversion part 70 converts the amount of electric charge for charge or discharge by the electrode part 65 into a detection voltage. Standard voltage is applied to the voltage conversion part 70 by the standard voltage application part 80. The amplifying part 90 amplifies and outputs the detection voltage. The temperature detection means 40, S103 detects fuel temperature and outputs a signal which is in accordance with the detected fuel temperature.

The fuel property detecting device 1 in the first aspect includes the storage means 100, the first calculation means 100, S102, the second calculation means 100, S104, the third calculation means 100, S105, the fourth calculation means 100, S107, the conductivity determination means 100, S106, and the abnormality determination means 100, S108. When the first calculation means 100, S102 calculates the capacitance of the electrode part 65 based on the amplified detection voltage, the second calculation means 100, S104 calculates the concentration of alcohol contained in fuel based on the capacitance calculated by the first calculation means 100, S102, the present fuel temperature detected by the temperature detection means 40, S103, and the map indicating a relationship between the capacitance of the electrode part 65 and the fuel temperature and stored in the storage means 100. When the third calculation means 100, S105 calculates the present electric conductivity σ2 of the electrode part 65 based on the amplified detection voltage, the conductivity determination means 100, S106 determines whether the present electric conductivity σ2 is the predetermined electric conductivity or higher. In the fourth calculation means 100, S107, the relationship between electric conductivity and fuel temperature is calculated based on the past electric conductivity σ10, σ11 of the electrode part 65, and the past fuel temperature T1 which are stored in the storage means 100, the present electric conductivity σ2 which is calculated by the third calculation means 100, S105, and the present fuel temperature T2. In the abnormality determination means 100, S108, it is determined whether the electrode part 65 is abnormal based on the relationship between electric conductivity of the electrode part 65 and fuel temperature which is calculated by the fourth calculation means 100, S107, and a coefficient of temperature properties indicating the relationship between electric conductivity of the electrode part 65 and fuel temperature which is stored in the storage means 100.

In the fuel property detecting device 1, properties of fuel, particularly, the concentration of alcohol contained in fuel are calculated from the capacitance of the capacitor 66 which is constituted of the electrodes 31, 32 of the electrode part 65, and the fuel between the electrodes 31, 32. However, the capacitance can be out of a predetermined stipulated range because of, for example, the abnormal fuel properties or the abnormal electrode part 65. In a conventional fuel property detecting device, it is determined that an electrode part is abnormal to replace the fuel property detecting device including the electrode part. However, when capacitance of the electrode part is out of the predetermined stipulated range due to the abnormal fuel properties, the electrode part is normal. In this case, in the conventional fuel property detecting device, the fuel property detecting device, which is normal, is replaced.

In the fuel property detecting device 1 in the first aspect, electric conductivity of the electrode part 65 is calculated, and the temperature property of electric conductivity is calculated based on the electric conductivity σ10, σ11 calculated in the past and the fuel temperature T1 at this time. It is determined whether the electrode part 65 is abnormal based on the coefficient of temperature properties indicating the relationship between electric conductivity of the electrode part 65 and fuel temperature which is stored in the storage means 100, and the calculated temperature property of electric conductivity. Accordingly, if the present electric conductivity σ2 is the predetermined electric conductivity or higher, whether the electrode part 65 is abnormal can be determined. If it is determined that the electrode part 65 is not abnormal, the fuel property detecting device 1 including the electrode part 65 is not replaced. Therefore, unnecessary replacement of the fuel property detecting device 1, which is normal, can be prevented.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A fuel property detecting device comprising:
an electrode part that includes electrodes immersed in fuel and that is charged with or discharges an amount of electric charge which changes according to a concentration of alcohol contained in fuel between the electrodes;
a voltage conversion part that is configured to convert the amount of electric charge, with which the electrode part is charged or which is discharged by the electrode part, into a detection voltage;
a standard voltage application part that is configured to apply a standard voltage to the voltage conversion part;
an amplifying part that is configured to amplify the detection voltage and to output the amplified detection voltage;
a temperature detection means for detecting fuel temperature and for outputting a signal that is in accordance with the detected fuel temperature;
a storage means for storing:
a map indicating a relationship between capacitance of the electrode part and the fuel temperature;
a coefficient of a temperature property indicating a relationship between electric conductivity of the electrode part and the fuel temperature;
a past electric conductivity of the electrode part; and
the fuel temperature detected by the temperature detection means at time of calculation of the past electric conductivity, as a past fuel temperature;
a first calculation means for calculating the capacitance of the electrode part based on the amplified detection voltage outputted by the amplifying part;
a second calculation means for calculating the concentration of alcohol contained in fuel based on:
the capacitance calculated by the first calculation means;
a present fuel temperature detected by the temperature detection means; and
the map;
a third calculation means for calculating a present electric conductivity of the electrode part based on the amplified detection voltage outputted by the amplifying part;
a conductivity determination means for determining whether the present electric conductivity calculated by the third calculation means is equal to or larger than a predetermined electric conductivity;
a fourth calculation means for calculating the relationship between the electric conductivity of the electrode part and the fuel temperature based on:
the past electric conductivity;
the past fuel temperature;
the present electric conductivity calculated by the third calculation means; and
the present fuel temperature; and
an abnormality determination means for determining whether the electrode part is abnormal based on:
the relationship between the electric conductivity of the electrode part and the fuel temperature calculated by the fourth calculation means; and
the coefficient of the temperature property.

2. The fuel property detecting device according to claim 1, wherein when a change rate of the electric conductivity of the electrode part relative to the fuel temperature is smaller than the coefficient of the temperature property, the abnormality determination means determines that the electrode part is abnormal.

3. The fuel property detecting device according to claim 1, wherein when a change rate of the electric conductivity of the electrode part relative to the fuel temperature is equal to or larger than the coefficient of the temperature property, the abnormality determination means determines that a fuel property is abnormal.
